(19) United States
(12) Patent Application Publication
(10) Pub. No.: US 2025/0293232 A1
(43) Pub. Date: Sep. 18, 2025

(54) METHOD OF MANUFACTURING ANODE STRUCTURE AND BATTERY INCLUDING ANODE STRUCTURE

(71) Applicant: National Taiwan University of Science and Technology, TAIPEI CITY (TW)

(72) Inventor: Fu-Ming WANG, New Taipei City (TW)

(21) Appl. No.: 18/967,663

(22) Filed: Dec. 4, 2024

(30) Foreign Application Priority Data
Mar. 18, 2024 (TW) 113110021

(51) Int. Cl. H01M 4/04; C23C 8/36; H01M 4/02; H01M 4/66; H01M 4/74; H01M 4/80

(52) U.S. Cl. CPC H01M 4/0426; C23C 8/36; H01M 4/0404; H01M 4/0445; H01M 4/661; H01M 4/664; H01M 4/667; H01M 4/74; H01M 4/808; H01M 2004/027

(57) ABSTRACT

A method of manufacturing an anode structure is provided in some embodiments of the present disclosure, including: performing an atmospheric-pressure plasma treatment on the copper-containing conductive layer to form a copper nitride film on the copper-containing conductive layer to obtain a transitional anode structure; charging a half-cell system to convert copper nitride in the copper nitride film into lithium nitride by connecting the transitional anode structure to a negative electrode and connecting the lithium-containing electrode to a positive electrode, thereby obtaining an anode structure.

### CROSS-REFERENCE TO RELATED APPLICATION

This application claims priority to Taiwan Application Serial Number 113110021, filed Mar. 18, 2024, which is herein incorporated by reference.

### BACKGROUND

### Field of Invention

A method of manufacturing an anode structure and a battery including the abovementioned anode structure are provided in some embodiments of the present disclosure.

### Description of Related Art

Lithium-Ion Battery (LIB) is widely used due to its advantages such as high energy density, high output voltage, and low self-discharge rate.

In order to further improve the energy density and reduce the battery volume, anode free lithium metal battery (AFLMB) was born accordingly. The main principle of AFLMB is the transfer of lithium, in which the anode structure does not have lithium metal as active ingredients, and lithium metal exists in the cathode structure. When the charging reaction occurs, lithium metal will be deposited on the anode structure to serve as an anode active ingredient. However, due to limitations in the deposition of the conductive layer (such as copper foil) in the anode structure and the reversible reaction efficiency of desorbed lithium, the electrochemical performance of the battery is limited.

Therefore, how to provide an anode structure that can enhance the reaction efficiency of lithium and improve electrochemical performance is a problem to be solved.

### SUMMARY

A method of manufacturing an anode structure is provided in some embodiments of the present disclosure, including: providing a copper-containing conductive layer; performing an atmospheric-pressure plasma treatment on the copper-containing conductive layer by using a reactive gas including a nitrogen-containing gas to form a copper nitride film on the copper-containing conductive layer to obtain a transitional anode structure; providing a lithium-containing electrode and a half-cell electrolyte; assembling a working electrode, an auxiliary electrode and the half-cell electrolyte into a half-cell system, in which the transitional anode structure is used as the working electrode, and the lithium-containing electrode is used as the auxiliary electrode; and charging the half-cell system to convert copper nitride in the copper nitride film into lithium nitride by connecting the transitional anode structure to a negative electrode and connecting the lithium-containing electrode to a positive electrode, thereby obtaining an anode structure, in which the anode structure includes the copper-containing conductive layer and a lithium nitride film covering the copper-containing conductive layer.

In some embodiments, the copper-containing conductive layer includes Cu foil, Cu mesh, Cu foam, or a combination thereof.

In some embodiments, before the step of performing the atmospheric-pressure plasma treatment on the copper-containing conductive layer, the method includes cleaning the copper-containing conductive layer by using an acid solution.

In some embodiments, the acid solution includes hydrochloric acid, acetic acid, nitric acid, or a combination thereof.

In some embodiments, a concentration of the acid solution is from 0.005 mol/L to 2 mol/L.

In some embodiments, the nitrogen-containing gas includes nitrogen gas, ammonia gas, or a combination thereof.

In some embodiments, the reactive gas further includes another inert gas.

In some embodiments, a volume ratio of the nitrogen-containing gas and the another inert gas is from 1:5 to 5:1.

In some embodiments, the step of performing the atmospheric-pressure plasma treatment on the copper-containing conductive layer includes moving a gas nozzle in S-curve motion profiles to perform the atmospheric-pressure plasma treatment on the copper-containing conductive layer.

In some embodiments, the lithium-containing electrode includes lithium metal sheet, lithium-containing compound, or a combination thereof.

In some embodiments, the half-cell electrolyte includes a lithium ion.

In some embodiments, the step of charging the half-cell system includes charging by using a current of from 0.1 mA/cm² to 0.5 mA/cm² until a voltage is 0 volts.

A battery is provided in some embodiments of the present disclosure, including: the anode structure manufactured according to the abovementioned method, a cathode structure and an electrolyte. The cathode structure includes lithium metal. The electrolyte is electrically connected to the anode structure and the cathode structure.

In some embodiments, the cathode structure further includes Ni, Co, Mn, Fe and Al.

In some embodiments, the electrolyte includes a lithium ion.

A method of manufacturing an anode structure is provided in some embodiments of the present disclosure, including: providing a copper-containing conductive layer; cleaning the copper-containing conductive layer by using an acid solution; forming a copper nitride film on the copper-containing conductive layer to obtain a transitional anode structure; providing a lithium-containing electrode and a half-cell electrolyte; assembling a working electrode, an auxiliary electrode and the half-cell electrolyte into a half-cell system, in which the transitional anode structure is used as the working electrode, and the lithium-containing electrode is used as the auxiliary electrode; and charging the half-cell system to convert copper nitride in the copper nitride film into lithium nitride by connecting the transitional anode structure to a negative electrode and connecting the lithium-containing electrode to a positive electrode, thereby obtaining an anode structure, in which the anode structure includes the copper-containing conductive layer and a lithium nitride film covering the copper-containing conductive layer.

In some embodiments, the acid solution includes hydrochloric acid, acetic acid, nitric acid, or a combination thereof.

In some embodiments, the step of forming the copper nitride film on the copper-containing conductive layer includes performing an atmospheric-pressure plasma treatment on the copper-containing conductive layer by using a reactive gas including a nitrogen-containing gas.

In some embodiments, the step of charging the half-cell system includes charging by using a current of from 0.1 mA/cm² to 0.5 mA/cm² until a voltage is 0 volts.

A battery is provided in some embodiments of the present disclosure, including: the anode structure manufactured according to the abovementioned method, a cathode structure and an electrolyte. The cathode structure includes lithium metal. The electrolyte is electrically connected to the anode structure and the cathode structure.

It is to be understood that both the foregoing general description and the following detailed description are examples and are intended to provide further explanation of the present disclosure as claimed.

### BRIEF DESCRIPTION OF THE DRAWINGS

In order to allow the above-mentioned and other purposes, features, advantages and embodiments of the present disclosure to be more clearly understood, accompanying drawing is described as follows:

FIG. 1 is a flow chart of a method of manufacturing an anode structure in some embodiments of the present disclosure.

FIG. 2 illustrates a movement pathway of the gas nozzle when treating the copper-containing conductive layer by using the atmospheric-pressure plasma in some embodiments of the present disclosure.

FIG. 3 is a flow chart of a method of manufacturing an anode structure according to some other embodiments of the present disclosure.

FIG. 4 illustrates a relationship figure between capacity, coulombic efficiency and cycle number of each group of half-cells during multiple charge and discharge cycles in the example of the present disclosure for comparing the half-cells after cleaning the copper-containing conductive layers by using different acid solutions.

FIG. 5A illustrates a relationship figure between capacity, coulombic efficiency and cycle number of each group of half-cells during multiple charge and discharge cycles in the example of the present disclosure for comparing the half-cells after cleaning the copper-containing conductive layers of different materials by using nitric acid.

FIG. 5B illustrates a relationship figure between capacity, coulombic efficiency and cycle number of each group of half-cells during multiple charge and discharge cycles in the examples of the present disclosure for comparing the half-cells after cleaning the copper-containing conductive layers of different materials by using hydrochloric acid (HCl).

FIG. 6A illustrates a relationship figure between discharge capacity, coulombic efficiency and cycle number of each group of the anode-free full cells during multiple charge and discharge cycles for comparing the anode-free full cells treated with or without the atmospheric-pressure plasma in the example of the present disclosure, in which the copper-containing conductive layer is made of Cu foil, and after treated with the atmospheric-pressure plasma, the charge and discharge cycle tests are conducted on the anode-free full cells having the aforementioned treated anode structures (the anode structures are not pre-charged, so the lithium nitride films are not pre-formed).

FIG. 6B illustrates a relationship figure between discharge capacity, coulombic efficiency and cycle number of each group of the anode-free full cells during multiple charge and discharge cycles for comparing the anode-free full cells treated with or without the atmospheric-pressure plasma treatment in the example of the present disclosure, in which the copper-containing conductive layer is made of Cu mesh, and after treated with the atmospheric-pressure plasma, the charge and discharge cycle tests are conducted on the anode-free full cells having the aforementioned treated anode structures (the anode structures are not pre-charged, so the lithium nitride films are not pre-formed).

FIG. 6C illustrates a relationship figure between discharge capacity, coulombic efficiency and cycle number of each group of the anode-free full cells during multiple charge and discharge cycles for comparing the groups treated with or without the atmospheric-pressure plasma in the example of the present disclosure, in which the copper-containing conductive layer is made of Cu foil, and after treated with the atmospheric-pressure plasma, the anode structure is charged to form the lithium nitride film, followed by conducting the charge and discharge cycle tests on the anode-free full cells having the aforementioned treated anode structures.

FIG. 6D illustrates during charge and discharge stages of the test of FIG. 6C, the morphological changes on the surfaces of Cu foils in the groups treated with or without the atmospheric-pressure plasma are observed with an electron microscope, respectively.

### DETAILED DESCRIPTION

It is to be understood that different implementations or embodiments provided in the following may implement different features of the subject matter of the present disclosure. The embodiments of specific components and arrangements are used to simplify the disclosure and not to limit the disclosure. Of course, these are only examples and are not intended to be limiting. For example, the description below that the first feature is formed on the second feature includes the two being in direct contact, or there are other additional features between the two that are not in direct contact. Furthermore, the present disclosure may repeat reference numerals and/or symbols in the various embodiments. Such repetition is for simplicity and clarity and does not represent a relationship between the various embodiments and/or configurations discussed.

Terms used in this specification generally have their ordinary meanings in the art and in the context in which they are used. The embodiments used in this specification, including examples of any terms discussed herein, are illustrative only and do not limit the scope and meaning of the disclosure or any exemplified terms. Likewise, the present disclosure is not limited to some of the implementations provided in this specification.

It will be understood that, although the terms “first,” “second,” etc., may be used herein to describe various elements, these elements should not be limited by these terms. These terms are used to distinguish one element from another. For example, a first element could be termed a second element, and similarly, a second element could be termed a first element, without departing from the scope of the embodiments.

As used herein, the phrase “and/or” includes any and all combinations of one or more of the associated listed items.

As used herein, the terms “comprise,” “include,” “has,” etc. are to be understood as open-ended, that is, to mean including but not limited to.

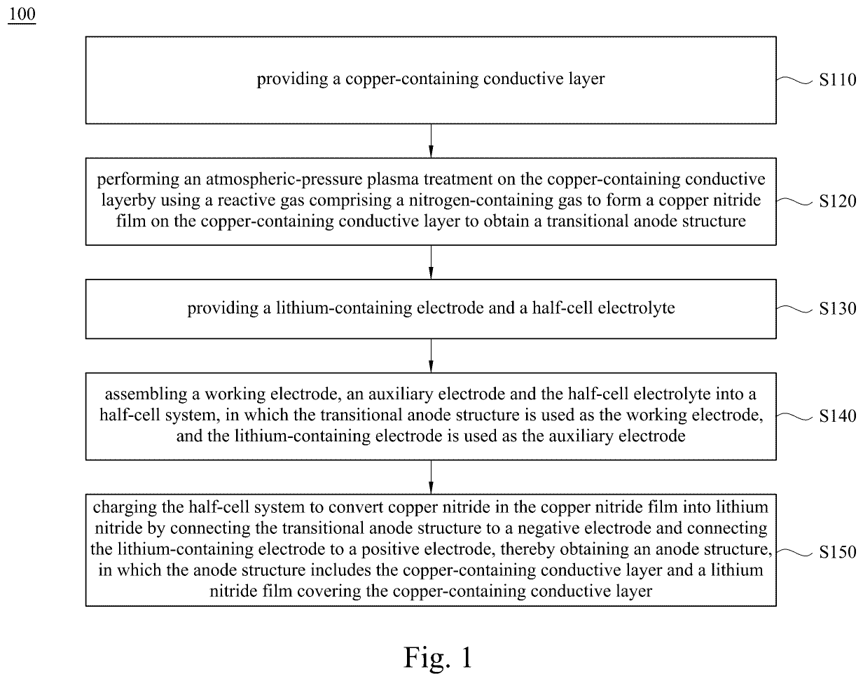

Please refer to FIG. 1, a method 100 is provided in some embodiments of the present disclosure, including step S110 to step S150.

It can be understood that, the method 100 forms a lithium nitride film on a copper-containing conductive layer by combining step S120 of treating a copper-containing conductive layer with an atmospheric-pressure plasma (forming a copper nitride film on the surface of the copper-containing conductive layer) and step S150 of performing a charging reaction on the treated copper-containing conductive layer (converting the copper nitride film into a lithium nitride film). By disposing the lithium nitride film, the lithium reactivity during the charge and discharge process is improved, thereby increasing the discharge capacity of the battery. The lithium nitride film also serves as a protective layer to reduce the generation of impurities during charge and discharge and extend the service life.

First of all, please refer to step S110, a copper-containing conductive layer is provided.

In some embodiments, the copper-containing conductive layer in step S110 includes Cu foil, Cu mesh, Cu foam (multiple connected or disconnected holes evenly distributed in the copper layer), or a combination thereof. Compared with other conductive materials, the selection of copper material as the conductive layer not only costs less, but also achieves excellent conductivity.

Please refer to step S120, an atmospheric-pressure plasma treatment on the copper-containing conductive layer is performed by using a reactive gas including a nitrogen-containing gas to form a copper nitride film on the copper-containing conductive layer to obtain a transitional anode structure.

In some embodiments, before the step of performing the atmospheric-pressure plasma treatment on the copper-containing conductive layer, the method 100 includes cleaning the copper-containing conductive layer by using an acid solution. Since copper in the copper-containing conductive layer is easily oxidized and copper oxide is formed on the surface, which reduces the electrochemical performance, the use of the acid solution for cleaning the copper-containing conductive layer can reduce the content of copper oxide on the surface, increase the capacity of the battery in which the anode structure is applied, increase coulombic efficiency and increase stability of battery performance.

In some embodiments, the acid solution includes hydrochloric acid, acetic acid, nitric acid, or a combination thereof. It is worth mentioning that, compared with cleaning by using other acid solution, the selection of cleaning by using nitric acid containing nitrogen atoms can provide the battery with more stable capacity and coulombic efficiency.

In some embodiments, at the step of cleaning the copper-containing conductive layer by using the acid solution, the concentration of the acid solution is from 0.005 mol/L (M) to 2 mol/L, such as 0.005 M, 0.01 M, 0.05 M, 0.1 M, 0.2 M, 0.5 M, 1 M, 1.5 M, 2 M, or a value in any aforementioned intervals. If the concentration is too low, the cleaning effect provided by copper oxide is limited. If the concentration is too high, the copper-containing conductive layer may be corroded.

In some embodiments, the nitrogen-containing gas includes nitrogen gas, ammonia gas, or a combination thereof. In some embodiments, the reactive gas further includes another inert gas, such as argon gas. In some embodiments, a volume ratio of the nitrogen-containing gas and another inert gas is from 1:5 to 5:1, such as 1:5, 1:3, 1:1, 3:1, 5:1, or a value in any aforementioned intervals. If the volume ratio is too low, the generation efficiency of the copper nitride layer is poor. If the volume ratio is too high, the effect of increasing the formation of the copper nitride layer is limited.

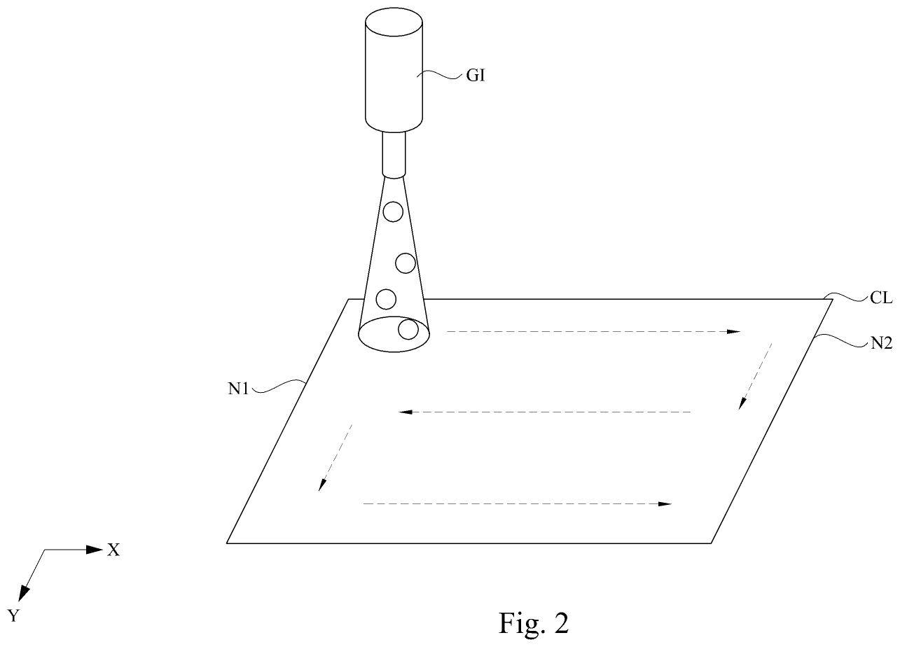

In some embodiments, the step of performing the atmospheric-pressure plasma treatment on the copper-containing conductive layer includes moving a gas nozzle in S-curve motion profiles to perform the atmospheric-pressure plasma treatment on the copper-containing conductive layer. Please refer to FIG. 2 for a schematic figure of a movement pathway of S-curve motion profiles. FIG. 2 represents that the pathway of S-curve motion profiles is that the gas nozzle GI moves from the first side N1 of the copper-containing conductive layer CL to the second side N2 relative to the first side N1 along the X-axis, then moves part of the distance along the Y-axis. Furthermore, the gas nozzle GI moves from the second side N2 back to the first side N1 along the X-axis. The gas nozzle GI moves and functions in the way of the abovementioned circular movement. The pathway of S-curve motion profiles ensures that the reactive gas acts evenly on the surface of the copper-containing conductive layer CL.

In some embodiments, the step of performing the atmospheric-pressure plasma treatment on the copper-containing conductive layer includes performing the atmospheric-pressure plasma treatment on the copper-containing conductive layer at the working condition that a plasma power is from 170 W to 300 W (170 W, 200 W, 250 W, 300 W or a value in any aforementioned intervals), and a gas flow rate is from 17 L/min to 24 L/min (such as 17 L/min, 20 L/min, 24 L/min or a value in any aforementioned intervals). If the plasma power is too high, the cost is much high but the improvement in the reaction efficiency is limited. If the plasma power is too low, the reaction efficiency is limited. If the gas flow rate is too high, the improvement in the reaction efficiency is limited. If the gas flow rate is too low, the reaction time takes too long.

It is understood that if copper nitride coating is formed by the methods such as plasma sputtering or evaporation, the production cost will be high and the structure of the copper nitride coating will be too dense. Because the structure of the copper nitride coating is too dense, the difficulty of copper ion replacement in copper nitride limits the subsequent conversion efficiency of lithium nitride, and the process requires considerable time and cost. Relatively, the copper nitride film formed through atmospheric-pressure plasma treatment not only has a lower processing cost, but also has a lower density. Copper nitride is easier to convert into lithium nitride during the subsequent charging process, which can achieve better lithium nitride conversion rate.

Therefore, please refer to steps S130 to step S150.

Step S130, a lithium-containing electrode and a half-cell electrolyte are provided. Step S140, a working electrode, an auxiliary electrode and the half-cell electrolyte are assembled into a half-cell system, in which the transitional anode structure is used as the working electrode, and the lithium-containing electrode is used as the auxiliary electrode. Step S150, the half-cell system is charged to convert copper nitride in the copper nitride film into lithium nitride by connecting the transitional anode structure to a negative electrode (the negative electrode of an external power supply) and connecting the lithium-containing electrode to a positive electrode (the positive electrode of an external power supply), thereby obtaining an anode structure, in which the anode structure includes the copper-containing conductive layer and a lithium nitride film covering the copper-containing conductive layer.

In some embodiments, the lithium-containing electrode includes lithium metal sheet, lithium-containing compound, or a combination thereof. When the lithium metal sheet is used, better charging efficiency in the charging reaction of step S150 can be achieved due to higher purity of lithium provided by the lithium metal sheet.

In some embodiments, the half-cell electrolyte includes lithium ions, which can be used for the charging reaction in step S140 to improve the efficiency of deposition and desorption reversible reaction of lithium ions. For example, the half-cell electrolyte includes lithium difluoro (oxalato) borate (LiDFOB).

In some embodiments, the step of charging the half-cell system includes charging by using a current of from 0.1 mA/cm² to 0.5 mA/cm² until a voltage is 0 volts. In some embodiments, the half-cell system is charged by using a current of 0.1 mA/cm², 0.2 mA/cm², 0.3 mA/cm², 0.4 mA/cm², 0.5 mA/cm² or a value in any aforementioned intervals. If the current is too low, the charging time is too long. If the current is too high, the generation efficiency and uniformity of the lithium nitride film will be poor.

It can be understood that, compared with the use that a copper-containing conductive layer having a copper nitride layer directly serves as the anode structure, the reactivity of lithium deposition during the charge and discharge process and the discharge capacitance can be increased by further performing the charging step of step S150 for converting the copper nitride layer into a lithium nitride layer. Furthermore, the lithium nitride layer can be used as a protective layer, the formation of impurities (lithium-containing branched compounds) due to electrolyte reactions can be reduce, thereby extending service life.

A battery is provided in some embodiments of the present disclosure, including the anode structure manufactured by the abovementioned method 100, a cathode structure and an electrolyte. The cathode structure includes lithium metal. The electrolyte is electrically connected to the anode structure and the cathode structure. Through the use of the anode structure of the method 100, better discharge capacity can be achieved and service life can be extended.

In some embodiments, the cathode structure further includes Ni, Co, Fe, Al and Mn. For example, the cathode structure includes LiNi_{0.8}Mn_{0.1}Co_{0.1}O₂. In some embodiments, the electrolyte includes a lithium ion. The use of the cathode structure and the electrolyte separately containing lithium metal and the lithium ions can be combined with the anode structure to form an anode free lithium metal battery (lithium metal or lithium ions are not included in the active ingredients in the anode structure, and lithium ions exist in the cathode structure, in which during the charging reaction, lithium ions will be deposited on the anode structure in the form of lithium metal to serve as the active ingredients of the anode electrode; AFLMB).

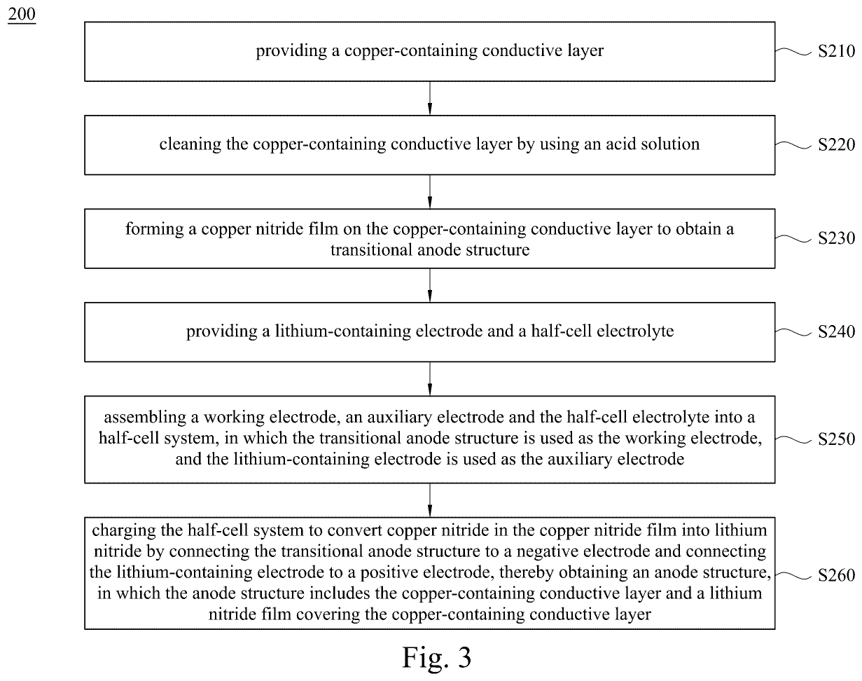

Please refer to FIG. 3, a method 200 of manufacturing an anode structure is further provided in some embodiments of the present disclosure, including step S210 to step S260. The difference between the method 100 of FIG. 1 and the method 200 of FIG. 3 is that the step of FIG. 1 includes the atmospheric-pressure plasma treatment of step S120, and the steps of FIG. 3 includes pre-cleaning the copper-containing conductive layer by using the acid solution of step S220.

In the method 200, the use of the acid solution for pre-cleaning the copper-containing conductive layer and then forming the copper nitride layer on the copper-containing conductive layer increases the capacity of the battery in which the anode structure is applied, increases coulombic efficiency and increases stability of battery performance.

A battery is provided in some embodiments of the present disclosure, including the anode structure manufactured by the abovementioned method 200, a cathode structure and an electrolyte. The cathode structure includes lithium metal. The electrolyte is electrically connected to the anode structure and the cathode structure. The details and functions of each component of the battery are as mentioned above and will not be described again here.

The following provides a series of examples of condition tests for the manufacture method of the anode structure to specifically illustrate some embodiments of the present disclosure.

### Example 1, Condition Test of Cleaning Copper-Containing Conductive Layer

### 1. Cu Foil

First, Cu foil served as the copper-containing conductive layer, and the acid solutions with different conditions were used for cleaning Cu foil, respectively. The conditions of the acid solutions were shown in Table 1 below.

TABLE 1

| Group | Condition |
|---|---|
| 1 | 1M hydrochloric acid (1M HCl) |
| 2 | 0.1M nitric acid (0.1M HNO₃) |
| 3 | 0.01M nitric acid (0.01M HNO₃) |
| 4 | 1M HCl and 0.1M HNO₃ |
| | (1M HCl + 0.1M HNO₃) |

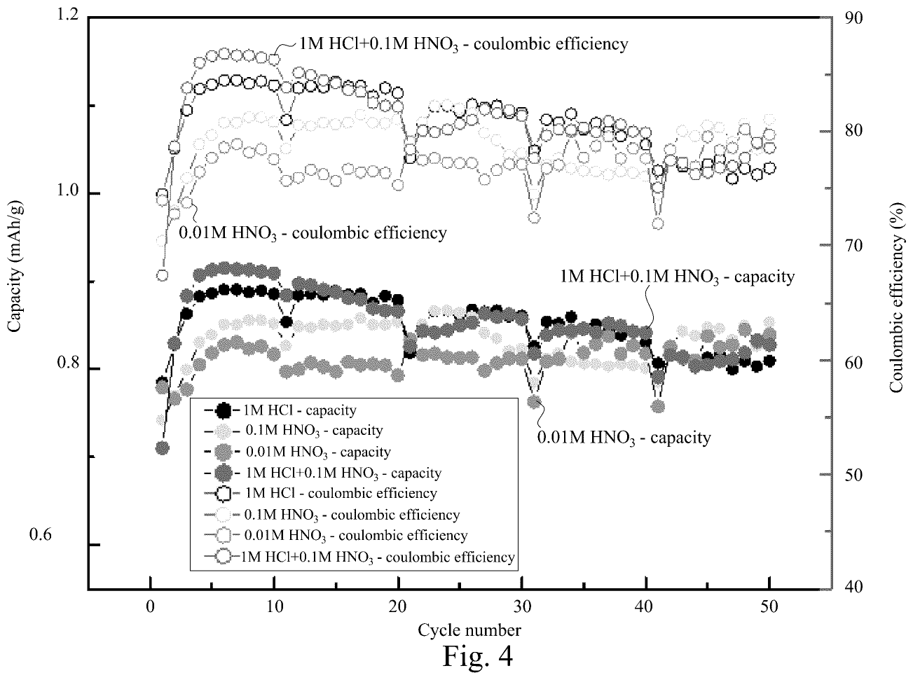

Furthermore, each group of Cu foils after cleaning by different cleaning condition served as a working electrode, Li foil served as an auxiliary electrode, 1M lithium difluoro (oxalato) borate (LiDFOB) dissolved in ethylene carbonate (EC) and dimethyl carbonate (DMC) served as a half-cell electrolyte (a volume ratio of EC and DMC was 1:1). The working electrode, the auxiliary electrode and the half-cell electrolyte were then assembled into a half-cell system, thereby performing multiple charge and discharge tests by selecting the condition that the charge voltage was 0 volts, the discharge voltage was 3 volts and the current of charge and discharge is 0.02 mA/cm², and then recording a relationship figure between capacity, coulombic efficiency and cycle number of each group of half-cells. Please refer to FIG. 4 for the results.

FIG. 4 represented that, compared with the group cleaned by using hydrochloric acid (such as Group 1M HCl and Group 1M HCl+0.1M HNO₃), the group cleaned by using nitric acid (Group 0.1M HNO₃ and Group 0.01M HNO₃) had less fluctuations in capacity and coulombic efficiency before and after the charge and discharge test, and the performance was more stable. This difference in performance may be related to the fact that nitric acid contains nitrogen atoms. Therefore, in addition to cleaning, nitric acid could also supply nitrogen atoms to assist in the subsequent formation of the copper nitride layer.

In addition, compared with nitric acid of different concentrations, it could be found that when the concentration of nitric acid was higher, the initial capacity and coulombic efficiency were higher.

### 2. Cu Mesh, Cu Foam and Cu Foil

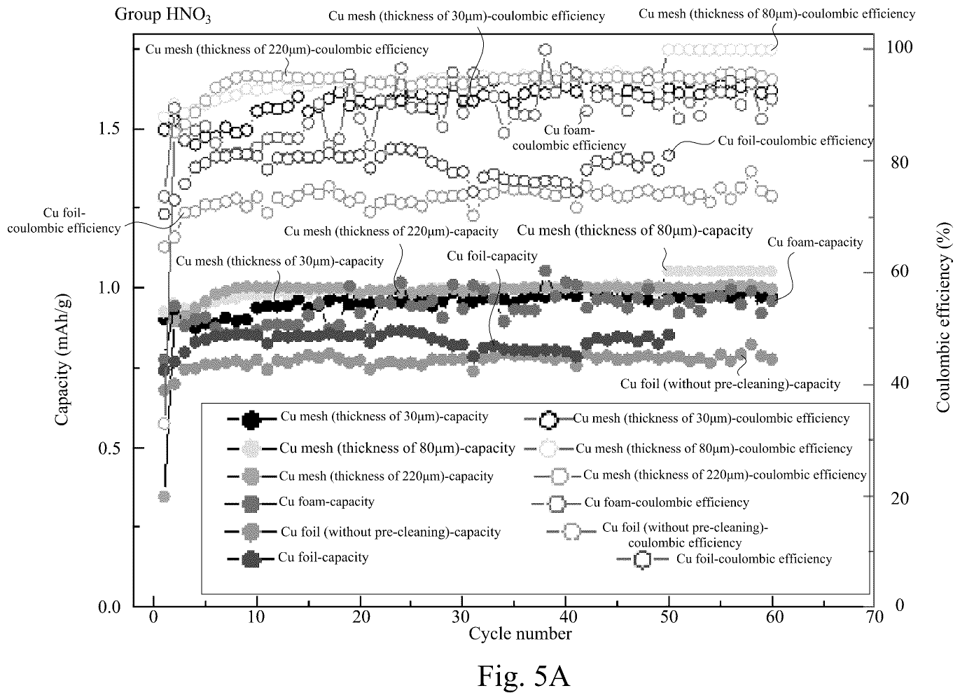

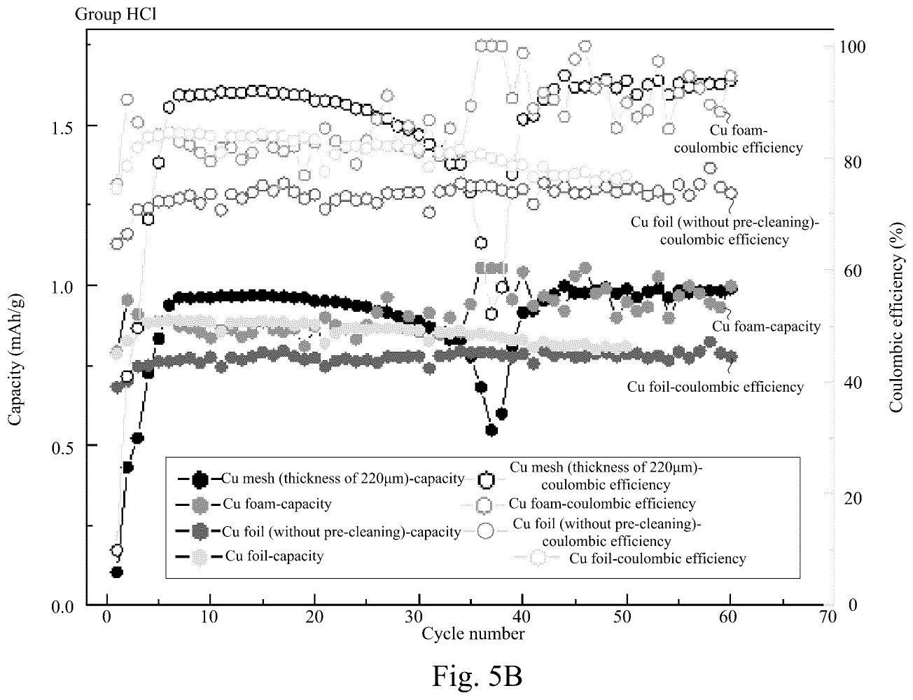

For further testing electrochemical performances of anode structures manufactured by using the different copper materials for serving as copper-containing conductive layers [three kinds of copper materials, Cu mesh, Cu foam or Cu foil, were compared, in which Group Cu mesh was divided into Group Cu mesh (thickness of 200 μm), Cu mesh (thickness of 80 μm), and Cu mesh (thickness of 30 μm) according to thickness] and after cleaning by using different acid solutions. Each group of the copper-containing conductive layer was pre-cleaned by using nitric acid (HNO₃) or hydrochloric acid (HCl), followed by performing multiple charge and discharge tests similar to the abovementioned point 1, and recording a relationship figure between capacity, coulombic efficiency and cycle number of each group of half-cells. Please refer to FIG. 5A (cleaned by using nitric acid) and FIG. 5B (cleaned by using hydrochloric acid) for the results.

FIG. 5A represented that, compared with Group Cu foil that was not cleaned by using nitric acid, Groups Cu mesh, Cu foam and Cu foil cleaned by nitric acid reduced the content of copper oxide on the surface, so higher capacity and coulombic efficiency could be achieved. FIG. 5B also represented a similar trend.

Furthermore, according to the comparison between FIG. 5A and FIG. 5B, it was represented that, compared with cleaning by using hydrochloric acid, Group Cu mesh (thickness of 220 μm) and Group Cu foam treated with nitric acid represented more stable performance of half-cells. Therefore, 0.1M nitric acid was selected as the subsequent cleaning condition.

### Example 2, Electrochemical Performance of Anode-Free Full Cells

### 1. Cu Foil Anode-Free Full Cell/Lithium Nitride Film not Pre-Formed

Cu foil was selected as the copper-containing conductive layer, and Cu foil was cleaned by using 0.1M nitric acid, followed by performing the atmospheric-pressure plasma treatment to form a copper nitride film covering an anode structure on Cu foil. The atmospheric-pressure plasma treatment was conducted by Atmospheric Pressure Plasma Jet (APPJ), which was performed by using reactive gas containing nitrogen gas and argon gas (a volume ratio of nitrogen gas and argon gas was 1:1), plasma power of from 170 W to 300 W, gas flow rate of from 17 L/min to 24 L/min, in which the gas nozzle moved according to the pathway of S-curve motion profiles.

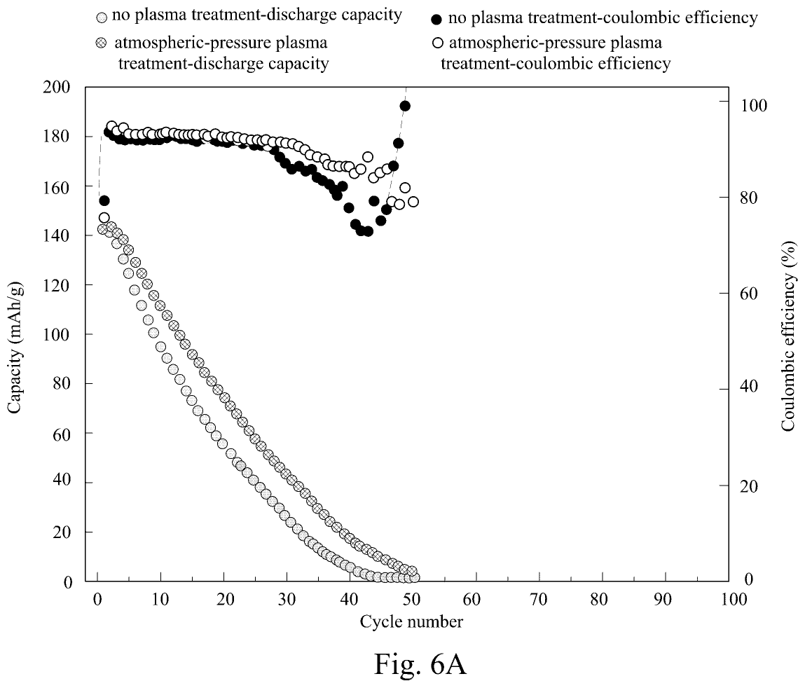

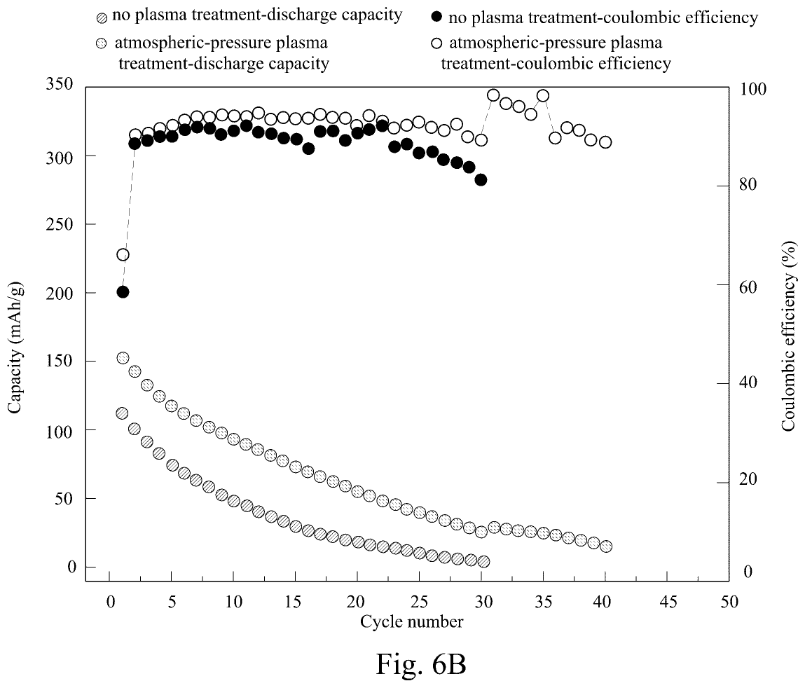

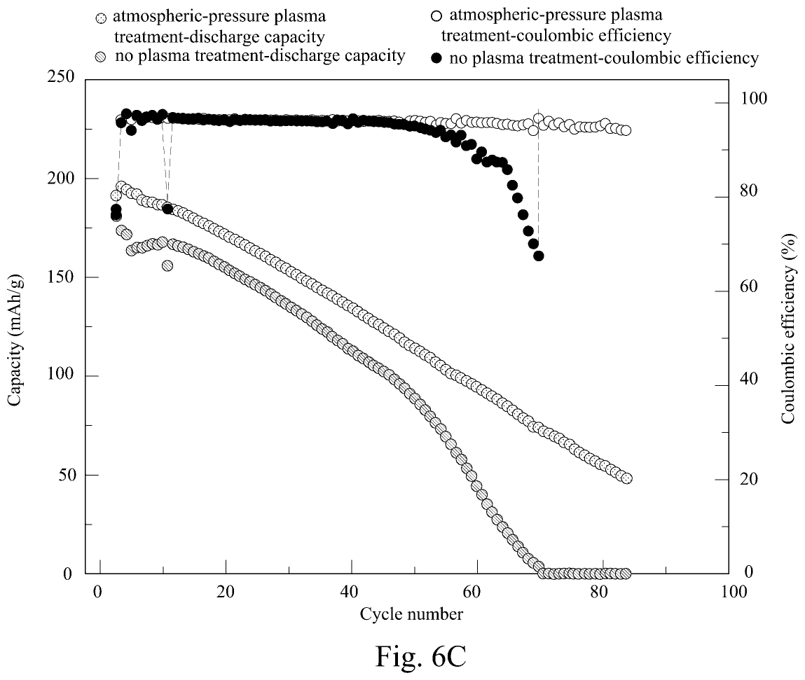

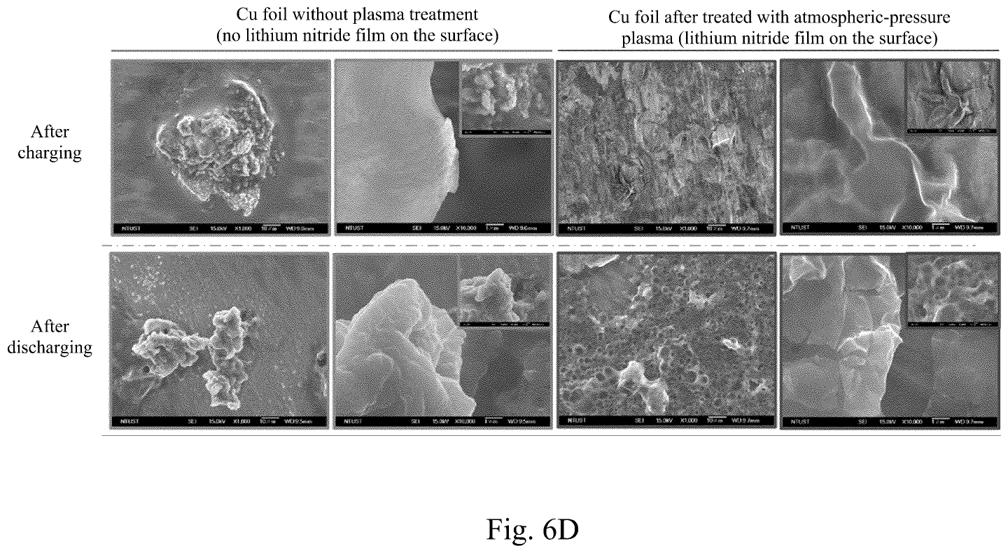

Furthermore, the anode structure was assembled into an anode-free full cell (cathode structure: Al sheet covered by NCM 811 (LiNi_{0.8}Co_{0.1}Mn_{0.1}O₂); electrolyte: the same as the abovementioned half-cell electrolyte of Example 1), and after the anode structure was formed, the charge and discharge cycle test was directly performed. Since the anode structure was not pre-charged, the lithium nitride film was not pre-formed. The charge voltage of the charge and discharge cycle test was 4.2 volts, the discharge voltage was 3 volts, and current of charge and discharge was 0.02 mA/cm². During the cycle testing process, a relationship figure between discharge capacity, coulombic efficiency and cycle number of each group of the anode-free full cells during multiple charge and discharge cycles was provided for comparing the groups treated with or without the atmospheric-pressure plasma. Please refer to FIG. 6A for the results, and initial charge capacity, initial discharge capacity and reversibility (initial discharge capacity/initial charge capacity×100%, initial coulombic efficiency) were represented on Table 2 below.

TABLE 2

| | | Initial | |
|---|---|---|---|
| | Initial Charge | Discharge | |
| | Capacity | Capacity | Reversibility |
| Group Cu foil | (mAh/g) | (mAh/g) | (%) |
| No Plasma Treatment | 184.57 | 142.81 | 77.37 |
| Atmospheric-Pressure | 176.54 | 143.02 | 81.01 |
| Plasma Treatment | | | |

FIG. 6A and Table 2 represent that, compared with Group no plasma treatment, Group atmospheric-pressure plasma treatment remained higher value of the overall discharge capacity and higher stability of the coulombic efficiency during the charge and discharge cycle.

### 2. Cu Mesh Anode-Free Full Cell/not Pre-Charged (Lithium Nitride Film not Pre-Formed)

Cu mesh was selected as the copper-containing conductive layer of the anode-free full cell, and Cu mesh was cleaned by using 0.1M nitric acid, followed by performing the atmospheric-pressure plasma treatment to form a copper nitride film covering an anode structure on Cu mesh. The atmospheric-pressure plasma treatment was conducted by Atmospheric Pressure Plasma Jet (APPJ), which was performed by using reactive gas containing nitrogen gas and argon gas (a volume ratio of nitrogen gas and argon gas was 1:1), plasma power of from 170 W to 300 W, gas flow rate of from 17 L/min to 24 L/min, in which the gas nozzle moved according to the pathway of S-curve motion profiles.

Furthermore, the anode structure was assembled into an anode-free full cell basically according to the method similar to the abovementioned point 1 of Example 2, and after the anode structure was assembled, the charge and discharge cycle test was performed. During multiple charge and discharge cycles, a relationship figure between discharge capacity, coulombic efficiency and cycle number of each group of the batteries was provided for comparing the groups treated with or without the atmospheric-pressure plasma. Please refer to FIG. 6B for the results, and initial charge capacity, initial discharge capacity and reversibility (initial discharge capacity/initial charge capacity×100%, initial coulombic efficiency) were represented on Table 3 below.

TABLE 3

| | | Initial | |
|---|---|---|---|
| | Initial Charge | Discharge | |
| | Capacity | Capacity | Reversibility |
| Group Cu mesh | (mAh/g) | (mAh/g) | (%) |
| No Plasma Treatment | 191.88 | 112.38 | 58.57 |
| Atmospheric-Pressure | 230.65 | 152.46 | 66.10 |
| Plasma Treatment | | | |

FIG. 6B and Table 3 represented that, compared with Group no plasma treatment, Group atmospheric-pressure plasma treatment had higher reversibility and higher value of the overall discharge capacity and coulombic efficiency during the charge and discharge cycle. Furthermore, Group atmospheric-pressure plasma treatment could last for more cycles and had a longer cycle life.

### 3. Cu Foil Anode-Free Full Cell/Pre-Charged (Pre-Formed Lithium Nitride Film)

Cu foil was selected as the copper-containing conductive layer of the anode-free full cell, and Cu foil was cleaned by using 0.1M nitric acid, followed by performing the atmospheric-pressure plasma treatment to form a copper nitride film covering an anode structure on Cu foil. The atmospheric-pressure plasma treatment was conducted by Atmospheric Pressure Plasma Jet (APPJ), which was performed by using reactive gas containing nitrogen gas and argon gas (a volume ratio of nitrogen gas and argon gas was 1:1), plasma power of from 170 W to 300 W, gas flow rate of from 17 L/min to 24 L/min, in which the gas nozzle moved according to the pathway of S-curve motion profiles.

Furthermore, the anode structure served as a working electrode, Li foil served as an auxiliary electrode, 1M lithium difluoro (oxalato) borate (LiDFOB) dissolved in ethylene carbonate (EC) and dimethyl carbonate (DMC) served as a half-cell electrolyte (a volume ratio of EC and DMC was 1:1). The working electrode, the auxiliary electrode and the half-cell electrolyte were then assembled into a half-cell system, followed by charging at current of 0.2 mA/cm² until the voltage was 0 volts. During the charging process, lithium ions replace with copper ions in the copper nitride film, thereby allowing the copper nitride film to convert into a lithium nitride film, and obtaining an anode structure (having the lithium nitride film covering Cu foil).

Furthermore, the anode structure was assembled into an anode-free full cell (cathode structure: Al sheet covered by NCM 811 (LiNi_{0.8}Co_{0.1}Mn_{0.1}O₂); electrolyte: the same as the abovementioned half-cell electrolyte of Example 1), followed by performing the charge and discharge cycle test similar to the condition of the abovementioned point 1 of Example 2. During multiple charge and discharge cycles, a relationship figure between discharge capacity, coulombic efficiency and cycle number of each group of the anode-free full cells was provided for comparing the groups treated with or without the atmospheric-pressure plasma. Please refer to FIG. 6C for the results.

FIG. 6C represented that, compared with Group no plasma treatment, Group atmospheric-pressure plasma treatment had higher discharge capacity, lasted for more cycles and had a longer cycle life.

Furthermore, according to the comparison between FIG. 6A and FIG. 6C, it was represented that FIG. 6A shows the anode-free full cell (FIG. 6A) that the anode structure was not pre-charged (the lithium nitride film was not pre-formed) had initial discharge capacity of about 145 mAh/g, and after 45 cylces, the coulombic efficiency obviously fluctuated and became unstable; FIG. 6C showed that the anode-free full cell that the anode structure was pre-charged had initial discharge capacity of about 190 mAh/g, and after 80 cylces, the coulombic efficiency remained stable. Therefore, the anode structure treated by pre-charging (pre-forming the lithium nitride film) could provide the anode-free full cell with higher capacity, and had better stability of the coulombic efficiency.

On the other hand, after the first charging, the morphological changes of the Cu foil surface of the groups with or without the atmospheric-pressure plasma treatment were observed with an electron microscope. Please refer to FIG. 6D.

FIG. 6D represented that the surface of Cu foil without plasma treatment easily reacted with the electrolyte during charge and discharge to generate impurities of lithium-containing branched compounds. Relatively, the surface of Cu foil treated by atmospheric-pressure plasma had the lithium nitride layer as the protective layer, making it less likely to generate impurities on the surface, thus extending the service life of the battery.

Although this disclosure has been described in detail with respect to certain embodiments, other embodiments are possible. Accordingly, the spirit and scope of the appended claims should not be limited to the embodiments described herein.

What is claimed is:

1. A method of manufacturing an anode structure, comprising:
providing a copper-containing conductive layer;
performing an atmospheric-pressure plasma treatment on the copper-containing conductive layer by using a reactive gas comprising a nitrogen-containing gas to form a copper nitride film on the copper-containing conductive layer to obtain a transitional anode structure;
providing a lithium-containing electrode and a half-cell electrolyte;
assembling a working electrode, an auxiliary electrode and the half-cell electrolyte into a half-cell system, wherein the transitional anode structure is used as the working electrode, and the lithium-containing electrode is used as the auxiliary electrode; and
charging the half-cell system to convert copper nitride in the copper nitride film into lithium nitride by connecting the transitional anode structure to a negative electrode and connecting the lithium-containing electrode to a positive electrode, thereby obtaining an anode structure, wherein the anode structure comprises the copper-containing conductive layer and a lithium nitride film covering the copper-containing conductive layer.

2. The method of claim 1, wherein the copper-containing conductive layer comprises Cu foil, Cu mesh, Cu foam, or a combination thereof.

3. The method of claim 1, wherein before the step of performing the atmospheric-pressure plasma treatment on the copper-containing conductive layer, the method comprises cleaning the copper-containing conductive layer by using an acid solution.

4. The method of claim 3, wherein the acid solution comprises hydrochloric acid, acetic acid, nitric acid, or a combination thereof.

5. The method of claim 3, wherein a concentration of the acid solution is from 0.005 mol/L to 2 mol/L.

6. The method of claim 1, wherein the nitrogen-containing gas comprises nitrogen gas, ammonia gas, or a combination thereof.

7. The method of claim 1, wherein the reactive gas further comprises another inert gas.

8. The method of claim 7, wherein a volume ratio of the nitrogen-containing gas and the another inert gas is from 1:5 to 5:1.

9. The method of claim 1, wherein the step of performing the atmospheric-pressure plasma treatment on the copper-containing conductive layer comprises moving a gas nozzle in S-curve motion profiles to perform the atmospheric-pressure plasma treatment on the copper-containing conductive layer.

10. The method of claim 1, wherein the lithium-containing electrode comprises lithium metal sheet, lithium-containing compound, or a combination thereof.

11. The method of claim 1, wherein the half-cell electrolyte comprises a lithium ion.

12. The method of claim 1, wherein the step of charging the half-cell system comprises charging by using a current of from 0.1 mA/cm² to 0.5 mA/cm² until a voltage is 0 volts.

13. A battery, comprising:
the anode structure manufactured according to the method of claim 1;
a cathode structure, comprising lithium metal; and
an electrolyte, electrically connected to the anode structure and the cathode structure.

14. The battery of claim 13, wherein the cathode structure further comprises Ni, Co, Mn, Fe and Al.

15. The battery of claim 13, wherein the electrolyte comprises a lithium ion.

16. A method of manufacturing an anode structure, comprising:
providing a copper-containing conductive layer;
cleaning the copper-containing conductive layer by using an acid solution;
forming a copper nitride film on the copper-containing conductive layer to obtain a transitional anode structure;
providing a lithium-containing electrode and a half-cell electrolyte;
assembling a working electrode, an auxiliary electrode and the half-cell electrolyte into a half-cell system, wherein the transitional anode structure is used as the working electrode, and the lithium-containing electrode is used as the auxiliary electrode; and
charging the half-cell system to convert copper nitride in the copper nitride film into lithium nitride by connecting the transitional anode structure to a negative electrode and connecting the lithium-containing electrode to a positive electrode, thereby obtaining an anode structure, wherein the anode structure comprises the copper-containing conductive layer and a lithium nitride film covering the copper-containing conductive layer.

17. The method of claim 16, wherein the acid solution comprises hydrochloric acid, acetic acid, nitric acid, or a combination thereof.

18. The method of claim 16, wherein the step of forming the copper nitride film on the copper-containing conductive layer comprises performing an atmospheric-pressure plasma treatment on the copper-containing conductive layer by using a reactive gas comprising a nitrogen-containing gas.

19. The method of claim 16, wherein the step of charging the half-cell system comprises charging by using a current of from 0.1 mA/cm² to 0.5 mA/cm² until a voltage is 0 volts.

20. A battery, comprising:
the anode structure manufactured according to the method of claim 16;
a cathode structure, comprising lithium metal; and
an electrolyte, electrically connected to the anode structure and the cathode structure.
